(19) United States
(12) Patent Application Publication
(10) Pub. No.: US 2026/0092595 A1
(43) Pub. Date: Apr. 2, 2026

(54) METHOD FOR CONSTRUCTING A WIND FARM WITH ALIGNMENT CONSTRAINTS

(71) Applicant: IFP Energies nouvelles, RUEIL-MALMAISON (FR)

(72) Inventor: Paul MALISANI, RUEIL-MALMAISON CEDEX (FR)

(21) Appl. No.: 19/113,449

(22) PCT Filed: Sep. 6, 2023
(86) PCT No.: PCT/EP2023/074435

§ 371 Date: Mar. 20, 2025

(30) Foreign Application Priority Data
Sep. 22, 2022 (FR) FR2209630

(51) Int. Cl. F03D 80/00; G06F 30/13; G06F 113/06

(52) U.S. Cl. CPC F03D 80/002; G06F 30/13; G06F 2113/06

(57) ABSTRACT

The invention relates to a method for constructing a wind farm in a predetermined space, wherein at least the following successive steps are carried out:
a) Forming (GR) various grids in the predetermined space,
b) For each grid, determining the average annual energy production of a mini-farm (AEP-mf) consisting of wind turbines at the points of intersection of a unit cell,
c) Choosing (Ch) a few grids that make it possible to maximize energy production,
d) For each grid c in step c), determining a first layout (Alg1) of the predefined number of wind turbines on the grid,
e) Modifying the position (Alg2) of the wind turbines on the grid,
f) Determining a definitive layout (Disp_F) of the wind turbines in the predetermined space, and constructing (Const) the wind farm.

### CROSS-REFERENCE TO RELATED APPLICATIONS

Reference is made to PCT/EP2023/074435 filed Sep. 6, 2023, and French Application No. 2209630, filed Sep. 22, 2022, both of which are incorporated herein by reference in their entirety.

### BACKGROUND OF THE INVENTION

### Field of the Invention

The present invention relates to a method for constructing a wind farm in a predetermined space.

### Description of the Prior Art

To meet environmental challenges, wind farms have emerged. These wind farms consist of a plurality of wind turbines that are spaced from one another in a delimited space. This delimited space may be on land or at sea. A distinction is thus drawn between onshore wind farms and offshore wind farms, that is, those at sea.

The wind turbines of these farms are generally wind turbines with a horizontal axis of rotation and that have a system for orienting the horizontal axis of rotation in line with the wind direction, in order to maximize the energy recovered by the wind turbine. Sometimes, the wind turbine is designed to automatically orient itself in the wind direction.

Wind turbines with a vertical axis of rotation, which have the advantage of not requiring orientation in the wind direction, are also known.

In wind farms, the wakes generated by wind turbines may have the effect of decreasing wind speed downstream of the wind turbine and therefore the energy recovered by other wind turbines, in particular those located downstream of those generating these wakes. The positioning of wind turbines in the farm is therefore important in order to maximize the energy recovered by the farm.

Moreover, in a location chosen to install a wind farm, local characteristics of the wind may vary. Indeed, wind direction and speed are in particular parameters that may vary over time at the location under consideration. These characteristics may be obtained in particular by sensors positioned at the defined location and kept at this position for several months or several years so as to obtain sufficient statistical data to characterize the wind resource at the chosen location. These sensors may in particular be anemometers positioned at a sufficient altitude (of the order of 100 m above ground level) to characterize the wind that will be seen by the wind turbines (that is to say the wind that is substantially level with the axis of the rotor for example). Wind data may also be obtained by light detection and ranging, also called LiDAR.

Statistical knowledge of the wind at the location under consideration of the farm makes it possible in particular to obtain the wind speed distribution, the wind direction distribution and the joint probability of occurrence of a wind speed in a given direction.

In order to maximize the annual energy produced by the farm, it is therefore necessary to position the wind turbines optimally in the planned location of the farm.

The term “annual energy produced” or “annual energy production” is understood to mean the average total energy produced by the farm, and therefore by all of the wind turbines of the farm. This average energy, which is estimated taking into account statistical wind data (wind speed distribution, wind direction distribution and probabilities of occurrence), is based on a duration of one year, hence the term “annual”, so as to avoid a seasonal influence that could distort the results. Indeed, wind, whether its speed or its direction, may vary greatly according to the seasons.

The average energy is obtained through knowledge of the wind direction distribution, of the wind speed distribution and of the probability of occurrence of a wind speed in a given direction. Of course, the annual energy produced also depends on the wind turbines that are chosen.

To determine a correct positioning of the wind turbines in the planned location of the farm, numerous methods have been developed.

Patent application CN105119320 relates to a method based on an evolution algorithm. This type of algorithm is stochastic, using random processes. This type of algorithm requires a significant number of tests in order to obtain a result, thereby generating a significant computation time, and requiring a large computer memory.

Patent applications CN102142103A, CN105139269 and US2016171401 relate to wind turbine positioning methods based on genetic algorithms. Genetic algorithms are a category of evolution algorithms. They require a multitude of evaluations and cross-referencing of these evaluations based on real possible (continuous) data. As a result, genetic algorithms are complex and therefore require a significant computation time and a large computer memory.

The methods described in the following documents are also known:
Tao S., Xu Q., Feijoo A., Zheng G., Zhou J., 2020. Wind farm layout optimization with a three-dimensional Gaussian Wake model. Renewable Energy, Volume 159, October 2020, Pages 553-569: This method requires the planned location of the farm to be delimited by a rectangle. In other words, this method is not suitable for farms comprising non-convex or even non-connected spaces.
Antonini E. G. A., Romerp D. A., Amon, C. H., 2018. Continuous adjoint formulation for wind farm layout optimization. Applied Energy, Volume 228, 15 Oct. 2018, Pages 2333-2345: This method is based on an analytical method for evaluating wake effects. This method is therefore a continuous optimization method, based on CFD (computational fluid dynamics) computations, which requires significant computation times and a large computer memory.
Wagner M., Day J., Neuman F., 2012. A fast and effective local search algorithm for optimizing the placement of wind turbines. Renewable Energy, Volume 51, March 2013, pages 64-70: Applying this method requires locations delimited by a rectangle. As a result, it is not suitable for locations having non-convex or non-connected shapes.
Feng J., Shen W. Z., 2015. Solving the wind farm layout optimization problem using random search algorithm. Renewable Energy, Volume 78, June 2015, Pages 182-192: This method requires locations delimited by polyhedra. As a result, it is not suitable for locations having non-connected shapes.
Quan N., and Kim H. M., 2018. Greedy robust wind farm layout optimization with feasibility guarantee. Engineering Optimization, Sep. 6, 2018, pages 1152-1167. This method is based on a greedy algorithm that takes into account all positions located at a minimum distance from wind turbines that have already been positioned in the location to determine the location of the following wind turbine. It therefore requires a significant computation time and a large computer memory, in particular if the discretization of the planned location of the farm is fine, if the space in which it is desired to place the wind turbines is large and/or if the number of wind turbines to be positioned is large.

Patent application WO 2022/028 847 from the applicant, which relates to a method for constructing a wind farm, is also known. In that method, the wind turbine installations are discrete positions in the predetermined space. Although satisfactory, this method does not implement wind turbine alignment constraints, thereby not facilitating the installation and maintenance of the wind turbines. Moreover, for offshore wind turbines and in order to facilitate navigation of boats, the alignment of wind turbines is one of the constraints of farm design.

The technical problem addressed by the invention thus is developing a method for constructing a wind farm that allows optimum positioning of wind turbines in locations having a complex shape, such as non-convex and/or non-connected areas, in order to maximize the total energy produced by the wind farm, while minimizing required computation time and computer memory and while complying with alignment constraints of the wind turbines in two directions forming a non-zero angle with one another (two non-parallel directions).

### SUMMARY OF THE INVENTION

In order to address the technical problem, the invention relates to a method for constructing a wind farm in a predetermined space, the wind farm having a predefined number of wind turbines, the construction method comprising a first discrete wind speed distribution, a second discrete wind direction distribution and a probability of occurrence of each discrete wind speed value in each discrete wind direction value of the first and second discrete distributions, wherein at least the following successive steps are carried out:
a) For various pairs of predefined first and second spacings, and for various pairs of predefined first and second directions, forming grids in the predetermined space, each grid being defined by a plurality of points of intersection between first lines oriented in the predefined first direction and second lines oriented in the predefined second direction, the first lines being spaced by the predefined second spacing along the predefined second direction and the second lines being spaced by the predefined first spacing along the predefined first direction, each grid comprising at least one unit cell delimited by the points of intersection;
b) For each grid in the predetermined space, determining the average annual energy production of a mini-farm having wind turbines positioned at all points of intersection of a unit cell or multiple connected unit cells of the grid, based on the first discrete wind speed distribution, on the second discrete wind direction distribution and on the probability of occurrence;
c) For each pair of predefined first and second spacings, associating at least one pair of predefined first and second directions that maximizes the annual energy production of the mini-farm;
d) For each grid corresponding to a pair of predefined first and second spacings and to a pair of predefined first and second directions associated in step c), determining a first layout of the predefined number of wind turbines, each wind turbine being positioned at one of the points of intersection of the grid by a first positioning algorithm;
e) Next, for each grid used in step d), modifying the position of the wind turbines in order to improve annual energy production, and obtaining a final layout of the predefined number of wind turbines on each grid under consideration and an annual energy production for each final layout; and
f) Determining a definitive layout of the wind turbines in the predetermined space, the definitive layout corresponding to the final layout obtained in step e) of the grid that maximizes annual energy production, and constructing the wind farm by erecting the wind turbines at the positions of the definitive layout in the predetermined space so as to generate energy from wind.

Preferably, in step e) of modifying the position of the wind turbines for each grid used in step d), at least the following steps are carried out:
e1) for each grid used in step d), defining a sequential order of modification of the positions of the wind turbines as determined by the first positioning algorithm and repositioning each wind turbine in the defined sequential order one by one by finding a point of intersection of the grid that maximizes annual energy production based on the first discrete wind speed distribution, on the second discrete wind direction distribution and on the probability of occurrence;
e2) reiterating step e1) as many times as necessary until, at the end of a step e1), no wind turbine has been repositioned, and obtaining a final layout of the predefined number of wind turbines on each grid under consideration and an annual energy production for each final layout.

Advantageously, the sequential order is obtained randomly.

Preferably, the sequential order is modified in each iteration of step e1).

According to one configuration of the invention, before step a), statistical wind data are measured using measuring devices, preferably a LIDAR sensor, in the predetermined space to determine the first and second discrete distributions and the probabilities of occurrence of each wind speed in each wind direction of the first and second discrete distributions.

According to one advantageous embodiment of the invention, the predetermined space comprises at least one of non-connected areas and/or non-convex areas.

According to one variant of the invention, for each grid under consideration, the first positioning algorithm carries out at least the following steps:
arbitrarily defining the position of the first wind turbine (P_E1) at one of the points of intersection of the grid;
next, for each wind turbine to be positioned, successively:
   defining potential positions (PE_Ej) for the wind turbine to be positioned, the potential positions (PE_Ej) being formed by the points of intersection of the grid that are located between a minimum distance and a maximum distance from all positioned wind turbines;
   computing the annual energy production (Eval_AEP) of the positioned wind turbines and of the wind turbine to be positioned for the defined potential positions (PE_Ej) based on the first discrete wind speed distribution (RD1), on the second discrete wind direction distribution (RD2) and on the probability of occurrence (Prob);
   choosing the position (Pos_j) of the wind turbine to be positioned, corresponding to the maximum computed annual energy production value:
determining the first layout (Disp_Ej) corresponding to the position of the predefined number of wind turbines among the points of intersection of the grid under consideration in the predetermined space (Esp).

Preferably, in step c), the difference is calculated between the annual energy production of the mini-farm obtained in step b) and the annual energy production of a single wind turbine multiplied by the number of wind turbines of the mini-farm.

The invention also relates to a wind farm obtained using the method for constructing a wind farm as described above.

### BRIEF DESCRIPTION OF THE DRAWINGS

Other features and advantages of the method and of the farm according to the invention will become apparent on reading the following description of non-limiting exemplary embodiments with reference to the appended figures described below.

FIG. 1 shows one example of a construction method according to the invention;

FIG. 2 shows one exemplary embodiment of the wind turbine repositioning steps of the construction method according to the invention;

FIG. 3 shows one example of a complex location for the positioning of wind turbines according to the invention;

FIG. 4 illustrates one variant of a first positioning algorithm according to the invention;

FIG. 5 illustrates the definition of wind turbine alignment constraints for the method according to the invention;

FIG. 6 illustrates the discontinuity of the points of intersection as a function of the spacings between the grid lines of the method according to the invention;

FIG. 7 illustrates the definition of a grid in a predetermined space and the points of intersection of the grid of the method according to the invention;

FIG. 8 illustrates a layout of the wind turbines on a grid in the predetermined space, the layout resulting from one of the steps of the method according to the invention, and this layout not being the definitive layout;

FIG. 9 illustrates the definitive layout of the wind turbines on the same grid as FIGS. 7 and 8, in the predetermined space obtained by the method according to the invention; and

FIG. 10 illustrates one example of searching for optimum positioning of twelve wind turbines in a predetermined non-convex space, with alignment constraints, in order to construct the wind turbines while maximizing annual energy produced, according to the invention.

### DETAILED DESCRIPTION OF THE INVENTION

In order to facilitate the reading of the present description, a few definitions are explained below.

A “greedy algorithm” is understood to mean an algorithm that establishes a local optimum step-by-step. In the case of a wind farm, it positions each wind turbine one after another until obtaining positioning of all wind turbines in the predetermined space.

An “evolution algorithm” is understood to mean a bio-inspired algorithm of which evolves a set of solutions to obtain better results. These are therefore stochastic and iteratively use random processes.

A “genetic algorithm” is understood to mean an evolution algorithm using the concept of natural selection. This type of algorithm may in particular cross-reference or modify certain parameters of previous solutions in order to improve results.

“Non-connected areas” is the name given to areas for which there are at least 2 points that cannot be connected by a continuous path contained entirely within the area in question. Conversely, a connected area is an area for which each pair of points is connected by a continuous path contained entirely within the area.

A “convex area” is the name given to an area in which the segments connecting any two points of this area are all contained entirely within the area. A circle, a square or a rectangle all delimit convex areas, for example.

Conversely, a “non-convex area” is an area in which there are at least two points connected by a segment that is not contained entirely within the area. For example, an area delimited by a concentric outer circle and inner circle is not convex.

In the present description, a “grid” is understood to mean a plurality of points of intersection located in the predetermined space (or at the boundary of this space). The points of intersection of the grid are points located at the intersection between first lines, all parallel to one another and oriented in the predefined first direction, and second lines, also all parallel to one another and oriented in the predefined second direction. The predefined first and second directions are defined with respect to a global reference frame; they are generally different from the wind direction (but may be collinear therewith in particular conditions). The first lines are spaced by a predefined second spacing along the second lines. In other words, the first lines are spaced regularly (they are all equidistant) by a step corresponding to the second spacing along the second lines. The second lines are spaced by a predefined first spacing along the first lines. In other words, the second lines are spaced regularly (they are all equidistant) by a step corresponding to the first spacing along the first lines. Each grid thus comprises at least one unit cell, having a parallelogram shape, delimited by points of intersection between the first and second lines (the first and second lines intersecting one another).

The invention relates to a method for constructing (or installing) a wind farm in a predetermined space, which may be an onshore area or an offshore area.

The farm has a predefined number of wind turbines. In other words, the (predefined) number of wind turbines that will be installed in the predetermined space has been defined beforehand.

Advantageously, the predetermined space may comprise non-connected areas. The predetermined space may therefore correspond to actual planned locations for the installation of wind turbines, for example a farm planned in a location comprising two areas separated by a road of significant width (several meters or even several tens of meters), such as a highway, or by a river.

Preferably, the predetermined space may comprise non-convex areas in addition or as an alternative to the non-connected areas. The predetermined space may thus correspond to real locations having a complex shape such as a space delimited by a steep hill or cliff, the coastline, the passage of a river or any other body of water. In an offshore configuration, the predetermined space may comprise non-convex areas that may in particular be determined taking into account bathymetry, the nature of the ground, borders with other countries, navigation channels, the passage of cables or pipelines, as examples.

FIG. 3 illustrates, schematically and in a non-limiting manner, one example of a predetermined space suitable for implementing the positioning method of the invention (or the method for constructing a wind farm of the invention).

The predetermined space may in particular comprise a first area Z1 and a second area Z2, are represented by vertical hatching. These areas Z1 and Z2 are not connected. Indeed, there is a non-zero minimum distance D between the two areas Z1 and Z2. Moreover, the area Z1 is rectangular. It is therefore convex. The area Z2 has a complex, non-convex shape. Indeed, if considering the two points A and B, it may be seen that part of the segment Seg connecting the points A and B is located outside the area Z2.

To identify the areas Z1 and Z2 of the predetermined space in a larger third area ZE, encompassing these two areas Z1 and Z2, it is possible to use a Boolean matrix. The third area ZE has a rectangular shape, this being easier to subject to computer processing than non-connected areas and/or non-convex areas such as Z1 and Z2. The Boolean matrix associates, with each discrete value (discrete position) of the area ZE, a value equal to 1 if the discrete position is located in the area Z1 or Z2, and a value 0 if it is located outside Z1 and Z2. This Boolean matrix makes it possible to define the determined space used for the method. It is possible, based on this Boolean matrix, to determine the one or more boundaries of the predetermined space. Indeed, a point will be considered to form part of the boundary if its value in the Boolean matrix is at 1 and if it has, among its direct neighbors, at least one point that has a value in the Boolean matrix at 0.

The construction method comprises a first discrete wind speed distribution, a second discrete wind direction distribution and a probability of occurrence of each discrete wind speed value in each discrete wind direction value of the first and second discrete distributions. These data may in particular be obtained by a wind data collector, such as a LIDAR (Light Detection And Ranging) sensor, a measuring mast or an anemometer. To this end, the construction method may advantageously comprise a preliminary collection step, before step a), during which the wind data measuring means (or collecting means) is installed in the predetermined space for a predetermined duration on the physical site of the predetermined space (the planned onshore installation region or the planned offshore area) in order to collect wind data from the site, and statistical wind data are thus measured by these measuring devices in order to determine the first and second discrete wind speed and wind direction distributions, and the probabilities of occurrence of each wind speed in each wind direction of the first and second discrete distributions. Wind data may be measured over the predetermined duration in order to collect measurements, the predetermined duration possibly being at least one year, in order to have data relating to the four seasons. It is thus possible to provide a step of collecting statistical wind data in the predetermined space using at least one collector.

The measuring (collecting) means may advantageously be a LIDAR sensor.

In this method, at least the following successive steps are carried out:
a) For various (first) pairs of predefined first and second spacings, and for various (second) pairs of predefined first and second directions, forming grids in the predetermined space, each grid being defined by a plurality of points of intersection between first lines oriented in the predefined first direction and second lines oriented in the predefined second direction, the first lines being spaced by the predefined second spacing along the predefined second direction and the second lines being spaced by the predefined first spacing along the predefined first direction, the grid comprising at least one unit cell delimited by the points of intersection (each unit cell is delimited by four points of intersection, and some points of intersection might not be related to a unit cell). The points of intersection of the grid thus form a discrete mesh. A discrete mesh is understood to mean that the points of intersection of the mesh formed by the grid are discrete values (as opposed to continuous values);
b) For each grid in the predetermined space, determining the average annual energy production of a mini-farm having wind turbines positioned at all points of intersection of a unit cell or multiple connected unit cells of the grid, based on the first discrete wind speed distribution, on the second discrete wind direction distribution and on the probability of occurrence;
c) For each (first) pair of predefined first and second spacings, associating at least one (second) pair of predefined first and second directions that maximizes the annual energy production of the mini-farm;
d) For each grid corresponding to a (first) pair of predefined first and second spacings and to a (second) pair of predefined first and second directions associated in step c), determining a first layout of the predefined number of wind turbines, each wind turbine being positioned at one of the points of intersection of the grid by a first positioning algorithm;
e) Next, for each grid used in step d), modifying the position of the wind turbines in order to improve annual energy production, and obtaining a final layout of the predefined number of wind turbines on each grid under consideration and an annual energy production for each final layout;
f) Determining a definitive layout of the wind turbines in the predetermined space, the definitive layout corresponding to the final layout obtained in step e) of the grid that maximizes annual energy production, and constructing the wind farm by erecting the wind turbines at the positions of the definitive layout in the predetermined space so as to generate energy from wind.

The use of discrete values for wind speed, wind direction and the discrete points of intersection of the various grids of the predetermined space makes it possible to simplify the method, speed up computation times and limit required computer memory, compared to methods using continuous real data. Indeed, discrete values make it possible to limit the number of possible combinations (reference is made to a combinatorial method), whereas continuous real data (reference is made to a continuous method) provide an infinite number of solutions. The combination of the first and second discrete distributions and the points of intersection of the grid thus makes it possible to obtain good accuracy of the positioning of the various wind turbines in the predetermined space, taking into account alignment constraints, while at the same time limiting the computation time required for this determination of the positions.

The probability of occurrence of each wind speed in each wind direction is used in particular to compute average annual energy production. This probability may in particular come from a wind rose corresponding to the predetermined space, this wind rose being well known to those skilled in the art. To establish this wind rose, it is possible in particular to use collectors as mentioned above, such as an anemometer positioned on a mast at a sufficient altitude (between 80 m and 120 m for example, so as to be substantially level with the hub of the wind turbine for example), or via a LiDAR (acronym from Light Detection And Ranging) sensor positioned close to the ground and oriented vertically. This collector is kept in place for a long period, several months and ideally more than one year, so as to be able to take into account for variations in wind characteristics according to the seasons.

According to one embodiment, annual energy production may be estimated using the following formula:

$$aep = 8760 \cdot {E}_{{w}_{s} , {w}_{p}} \{ P ( f , {w}_{s} , {w}_{p} ) \} \qquad [ Math 1 ]$$

Where aep is the annual energy production of the wind farm and
E_{w}_{ₛ}_{,w}_{ₚ}{P (f, wₛ, wₚ)} is the expectation of the total power produced by the wind farm (by the predefined number of wind turbines in the predetermined space) with respect to the law of joint probability of wind speed wₛ and wind direction wₚ. Therefore, the total power produced by the farm takes into account a statistical distribution of each wind speed wₛ in each wind direction wₚ, for example through a Weibull distribution.

If the rotors of the wind turbines are systematically aligned in a plane orthogonal to the wind direction wₚ, the total power produced by the farm may be written:

$$P ( f , {w}_{s} , {w}_{p} ) = {\sum }_{f = 1}^{N} {P}_{w} ( {w}_{s} , {w}_{p} ) \qquad [ Math 2 ]$$

Where N is the predefined number of wind turbines of the farm in the predetermined space, Pf is the instantaneous power supplied by each wind turbine f in the farm for each wind speed wₛ in each wind direction wₚ.

If some rotors of the wind turbines were to be in a plane off-axis with respect to the plane orthogonal to the wind direction wₚ (in other words, the wind turbine is not oriented facing the wind, but is off-axis with respect thereto), a corrective factor may be taken into account in order to account for the effect of being off-axis. This corrective factor may result in particular from CFD (computational fluid dynamics) simulations.

The instantaneous power Pf of each wind turbine f in the farm may be written:

$${P}_{w} ( {w}_{s} , {w}_{p} ) = \frac{1}{2} \cdot ρ \cdot S \cdot {v}_{w}^{3} ( {w}_{s} ) \cdot {C}_{pf} [ {v}_{w} ( {w}_{s} ) ] \qquad [ Math 3 ]$$

Where ρ is air density, S is the surface swept by the rotor of the wind turbine f, v_{w}(ws) is wind speed at the rotor of the wind turbine f and the power coefficient C_{pf} of the wind turbine f depending on wind speed vw(wₛ) at the rotor of the wind turbine f, the power coefficient C_{pf} being a characteristic of the wind turbine f.

Indeed, the wake effects of wind turbines located upstream and/or to the side of the wind turbine f may impact the energy production of the wind turbine f. This wake may generate a decrease in wind speed at the wind turbine f and/or wind turbulence. The impact of these wake effects is that the speed v_{f} at the rotor of the wind turbine no longer corresponds to the speed ws and that the power coefficient C_{pf} is then also impacted.

The impacts of wake effects taken into account in equation [Math3] may be based in particular on wake models. These wake models may in particular reflect:
a reduction in wind speed upstream of the wind turbine f due to the wake from an upstream wind turbine. Such a model, which is well known to those skilled in the art, is the Jensen wake model (described in the publication “A simple model for Cluster Efficiency”, Katic, Hojstrup and Jensen, EWEC 1986, in particular in paragraph 2.1 of that publication),
an increase in turbulent intensity of the wind,
and/or a superposition of wakes from multiple upstream wind turbines on one and the same wind turbine f, as described in the publication “A note on wind generator interaction” Jensen, D T U, 1983. This wake superposition may combine the effects of reducing wind speed, as in the publication cited above, and/or turbulent intensity of the wind from multiple wakes.

The wake models may also be determined based on CFD (computational fluid dynamics) computations.

The above formulas may be used to compute the annual energy produced by the farm consisting of the predefined number of wind turbines, by the mini-farm or by a farm consisting of a single wind turbine.

Preferably, in step e) of modifying the position of the wind turbines for each grid used in step d), at least the following steps may be carried out:
e1) for each grid used in step d), defining a sequential order of modification of the positions of the wind turbines as determined by the first positioning algorithm and repositioning each wind turbine in the defined sequential order one by one by finding a point of intersection of the grid that maximizes annual energy production based on the first discrete wind speed distribution, on the second discrete wind direction distribution and on the probability of occurrence.
e2) Reiterating step e1) as many times as necessary until, at the end of a step e1), no wind turbine has been repositioned, and obtaining a final layout of the predefined number of wind turbines on each grid under consideration and an annual energy production for each final layout.

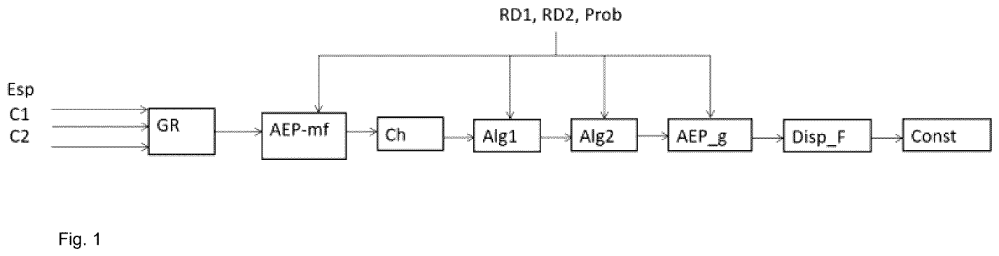

FIG. 1 illustrates, schematically and in a non-limiting manner, the method for constructing the wind farm in a predetermined space Esp, in a global manner.

Based on the chosen predetermined space Esp (an offshore or onshore geographical area), which may be a space comprising at least one of non-convex and non-connected areas (for example with a road or river crossing this space), and various first pairs C1 of predefined first and second spacings and various second pairs C2 of predefined first and second directions, grids (GR) are established in the predetermined space.

Each of these grids (GR) is established from a multitude of first lines that are parallel to one another and spaced regularly and second lines that are parallel to one another and intersect the first lines (in other words, the angle formed between the first lines and the second lines is non-zero and non-flat).

The various grids GR are distinguished from one another by the combination of the first pairs C1 and second pairs C2.

For each grid GR, the first lines are oriented at an angle corresponding to the first direction with respect to a direction of a predefined fixed reference frame (for example, a reference frame with a North direction and an East direction), and the second lines are oriented at an angle corresponding to the second direction with respect to the same direction of the predefined fixed reference frame (the North direction for example).

The first lines are spaced by the predefined second spacing along the second lines and the second lines are spaced by the predefined first spacing along the first lines.

A first line and a second line may be positioned arbitrarily in the space, these lines then serving as a reference to the positions of the other lines.

The points of intersection between the first lines and the second lines that are located in the predetermined space (within the predetermined space, the boundary of this predetermined space advantageously being included or, by contrast, being able to be excluded) define the grid.

The grid may thus comprise unit cells, and the unit cells of the grid form parallelograms given the parallelism of the first and second lines, delimited by the lines and the points of intersection.

For each defined grid GR, the annual energy production of a mini-farm AEP-mf is determined. Annual energy production is based on statistical wind data from for example a LIDAR sensor or any other wind data measuring devices, these statistical data comprising a first discrete wind speed distribution RD1, a second discrete wind direction distribution RD2 and a probability of occurrence Prob of each wind speed value of the first discrete distribution RD1 in each wind direction of the second discrete distribution RD2.

The mini-farm is a farm having a grid portion with at least one unit cell of the grid (or multiple connected unit cells) and where a wind turbine is positioned at all points of intersection of this grid portion. Thus, if the grid portion comprises just a single unit cell, the mini-farm will have four wind turbines, one at each point of intersection of the unit cell. This situation with a mini-farm of four wind turbines is advantageous because it makes it possible to evaluate the impact of the wake of the wind turbines on one another on the grid easily and quickly, without the need for a large amount of memory or computation time when this step is computer-implemented.

Within the meaning of the present description, a unit cell is understood to mean an elementary unit cell which means that a parallelogram delimited by four points of intersection is considered to be a unit cell if this parallelogram does not comprise any other parallelogram defined by four points of intersection, within itself.

By comparing the annual energy production values of various grids comprising the same first pair C1 and various second pairs C2, it is possible to associate one or more most promising pairs C2 (giving the one or more greatest annual energy productions). Thus, one or more second pairs C2 are associated for each first pair C1 of predefined first and second spacings. This makes it possible to limit the number of combinations of first pairs C1 and second pairs C2 for the remainder of the method.

Annual energy production values may be compared directly (direct comparison of the various values is used to then look for the second pairs C2 that maximize annual energy produced) or indirectly. In the latter case, the annual energy produced by the mini-farm is compared to the annual energy produced by the same number of wind turbines as that of the mini-farm as if each wind turbine were independent (therefore without taking into account wake effects): loss related to the wake effects of the mini-farm will then be estimated. In this case, of course, the one or more second pairs C2 that minimize loss related to wake effects will be retained.

It is thus possible to choose Ch, based on the annual energy production of the mini-farms, at least one second pair C2 for each first pair C1. A certain number of grids are thus selected from those that have been established beforehand.

Next, for each selected grid, a first layout of the wind turbines Alg1 on this grid (at points of intersection of this grid) is determined. This first layout seeks to obtain a good energy output, and therefore takes into account the first and second discrete distributions RD1 and RD2 and the probability of occurrence Prob.

Based on this first layout of the wind turbines on each selected grid, it is then sought to improve energy recovery. The wind turbines are then repositioned Alg2 on the grid by seeking, each time a wind turbine is repositioned, to find the position on the grid that makes it possible to obtain the highest annual energy produced. Of course, to achieve this, the first and second discrete distributions RD1 and RD2 and the probability of occurrence Prob are taken into account.

Once the wind turbines have been repositioned and no better solution is able to be found (it is no longer possible to change a wind turbine position on the grid without degrading the annual energy produced), a final layout of the wind turbines on each selected grid has therefore been found, and the annual energies produced by each grid AEP_g are compared. It is then possible to determine the definitive layout Disp_F of the wind turbines in the predetermined space Esp as being the final layout of the wind turbines on the grid that makes it possible to obtain the maximum annual energy produced.

The wind turbines are then constructed Const at the planned locations corresponding to the determined definitive layout in the predetermined space.

### Step a) of Defining the Grids

This step makes it possible to define multiple possible grids within the predetermined space. Each grid therefore has a spatial limit and cannot exceed the predetermined space. This grid comprises one or more unit cells separated by points of intersection. These unit cells have a parallelogram shape, for example a rectangular or square shape, and the points of intersection are at the boundary between the unit cells. All unit cells and all points of intersection of each grid are located within the predetermined space.

The unit cells of each grid are defined between the first lines and the second lines. These grids each constitute a possible option for placing the wind turbines of the farm in the predetermined space, taking into account alignment constraints (along the first and second lines). The points of intersection of each grid constitute possible positions for the installation of a wind turbine. By using multiple grids, it is possible to test various alignment constraints (various values of predefined first and second spacings and various values of predefined first and second directions). The first and second directions are non-collinear and form a non-zero (and non-flat) angle so as to consider two-dimensional alignment constraints in the space, such that the first lines and the second lines intersect.

Using various discrete values limits the number of possible combinations and therefore the useful memory of the computer. Moreover, these discrete values are sufficient to ensure accuracy compatible with the construction of wind turbines in situ (taking into account possible construction accuracies).

The predefined first and second spacings are advantageously between a minimum distance and a maximum distance, these minimum and maximum distances depending for example on the diameter of the rotor of the wind turbine. The minimum distance corresponds to the minimum value by which two successive wind turbines must be separated in order to limit energy losses related to wake effects, and the maximum distance corresponds to the maximum value by which two wind turbines must be separated, a greater distance not resulting in any gain in energy recovery and limiting the possibility of installing enough wind turbines in the predetermined space to ensure a sufficient energy output.

Indeed, predefined first and/or second spacings smaller than the minimum distance or greater than the maximum distance are not necessary since wind turbines have to comply with a minimum distance between one another in order to avoid excessive energy losses related to wake effects and a maximum distance in order to install the predefined number of wind turbines and obtain beneficial energy output from the farm in the space.

Preferably, the minimum distance may be greater than twice the diameter of the rotor of the wind turbines, and preferably greater than four times the diameter of the rotor of the wind turbines; the maximum distance may be at least four times the diameter of the wind turbines and preferably at least eight times the diameter of the wind turbines.

Preferably, the predefined first direction may be between −90° and 90°, taking into account symmetry, with respect to an orthonormal reference frame, for example the terrestrial reference frame with North located at 90° and South at −90°, this orthonormal reference frame preferably being the one used to define wind directions.

And preferably, the predefined second direction may be between −90° and the first direction. Therefore, with symmetry effects, the entire possible space is swept while limiting the number of combinations.

The discrete values of the predefined first and second spacings may be defined in steps of 0.5 times the diameter of the rotor, and discrete values of the predefined first and second directions may be defined in steps of 1°, these steps being sufficient to obtain sufficient accuracies at the locations of the wind turbines.

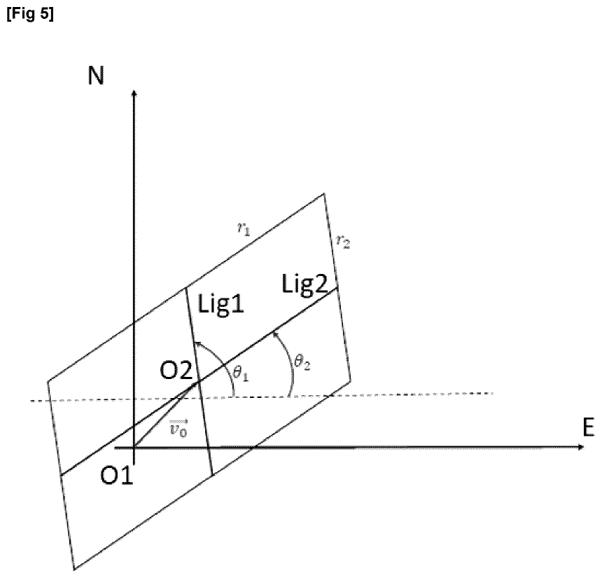

FIG. 5 illustrates, schematically and in a non-limiting manner, the change of reference frame between the reference frame (O1, N, E), which corresponds to the global reference frame, O1 being able to be based arbitrarily, N possibly corresponding to the North direction and E to the East direction, and a reference frame tied to the grid, with O2 being a point fixed arbitrarily on a point of intersection between a first line Lig1 and a second line Lig2 of the grid, the first line Lig1 and the second line Lig2 intersecting one another. Here, the first line Lig1 forms an angle θ1 with the direction E and the second line Lig2 forms an angle θ2 with the direction E (alternatively, it is also possible to have the first line Lig1 forming an angle θ1 with the direction N and the second line Lig2 forming an angle θ2 with the direction N). The reference frame (O1, N, E) may advantageously be the one used to determine wind directions.

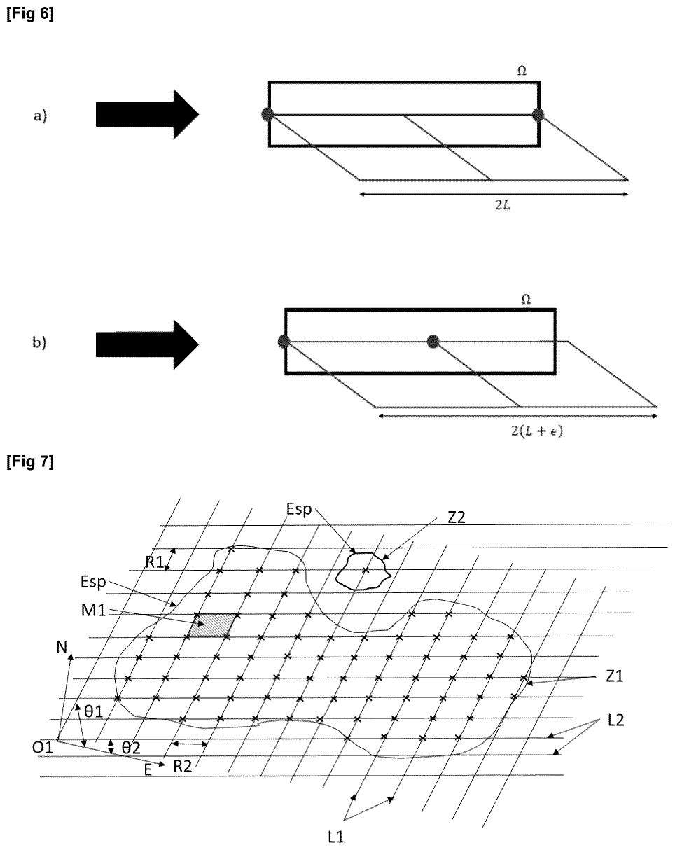

FIG. 6 illustrates, schematically and in a non-limiting manner, the discontinuity of the positions that may result from various grids, because of the different mesh.

In this figure, Ω represents the predetermined space. Only one line is shown on the grid for ease of understanding.

In diagram a), the points of intersection on the line are separated by a length L. It is therefore possible to position the wind turbines, represented by the black dots, at each end of the predetermined space Ω: they are therefore spaced by a distance corresponding to 2L.

In diagram b), the points of intersection on the line are separated by a length L+ε. It is therefore possible to position the wind turbines, represented by the black dots, only at the points of intersection that are shown: they are therefore spaced by a distance corresponding to L+ε. Indeed, the point located at 2(L+8) is outside the domain of the predetermined space Ω.

Thus, even if the value & is low, there will be a strong discontinuity of solutions between a grid with lines spaced by a space L and those spaced by a space L+εbecause of the limit of the predetermined space for determining the grid and the points of intersection taken into account for the choice of possible positions of the wind turbines.

### Step b) of Determining the Annual Energy Production of a Mini-Wind Farm on Each Grid

Step a) Makes possible defining a panel of grids in which the points of intersection of each grid are points that may correspond to the installation of a wind turbine. Of course, in order to verify the alignment constraints of the wind turbines, it is not possible, in this construction method, to use points of intersection of a grid to install some of the wind turbines with points of intersection of another grid to install other wind turbines.

In order to avoid searching for the optimum layout of the wind turbines on each grid, by computing annual energy production each time, it is preferable to carry out sorting so as to use only grids likely to offer the best possibilities of finding the optimum layout. Step b) seeks to carry out this first sorting among the various grids.

To this end, for each grid formed in step a), consideration is given to a mini-farm having only wind turbines at each point of intersection of the grid portion under consideration. The grid portion corresponds to a few connected unit cells (a few unit cells all connected to one another), and preferably to a single grid, to further simplify the sorting.

By virtue of all of the wind turbines installed on the grid portion (for example, four wind turbines if the grid portion comprises a single unit cell, 9 wind turbines if the grid portion is homothetic by a factor of 2 compared to a grid with a single unit cell), it is possible to determine the annual energy production of the mini-farm, in particular by way of the formulas presented above.

It is thus possible to associate an annual energy production of the mini-farm for each type of grid.

### Step c) of Choosing (Second) Pairs of Predefined First and Second Directions as a Function of the Predefined First and Second Spacings.

This step is used to limit the number of combinations to be used for the layout of the predefined number of wind turbines of the farm based on the results obtained in step b). Indeed, by virtue of the mini-wind farm, it is possible to estimate, for various (first) pairs of predefined first and second spacings, annual energy production as a function of the (second) pair of predefined first and second directions and of the first and second discrete wind speed and wind direction distributions and of the probability of occurrence of each discrete wind speed value in each discrete wind direction value.

It is then possible to choose at least one (preferably only one) (second) pair of predefined first and second directions for each (first) pair of predefined first and second spacings, so as to limit the number of combinations for the remainder. Indeed, for the (first) pair of predefined first and second spacings, the one (or more) (second) pair(s) of predefined first and second directions make it possible to maximize the annual energy produced and/or to limit wake effects.

To determine the one (or more) (second) pair(s) of first and second directions associated with each (first) pair of predefined first and second spacings, it is possible either to directly compare the annual output produced and retain the pairs of directions that maximize this annual production of the mini-farm or to compare the loss of recovered energy due to wake effects.

In this second case, the energy loss of the mini-farm under consideration is determined in relation to the ideal production of the same number of wind turbines as the mini-farm, without taking into account the wake effects of the wind turbines on one another. Thus, in step c), the difference may for example be calculated between the annual energy production of the mini-farm obtained in step b) and the annual energy production of a single wind turbine multiplied by the number of wind turbines of the mini-farm. This energy loss Ploss may be determined using the following formula:

Pₗₒₛₛ=n*aep(f1,ws,wp)−aep(f2,ws,wp) [Math 4]

Where aep(f1, ws, wp) is the annual energy produced according to the formula [Math 1] for a farm f1 consisting of a single wind turbine in the predefined space, and where aep(f2, ws, wp) corresponds to the annual energy produced according to the formula [Math 1] for a farm f2 consisting of a number n of wind turbines in the mini-farm of the predefined space, ws and wp being the wind speed and wind direction statistical distributions, taking into account the probabilities of occurrence mentioned above.

The advantage of this formula [Math 4] is that it provides direct information about the impact of the wake effects of the mini-farm, the effect depending directly on the chosen alignment directions and spacings. It is then possible to discard solutions for which losses are excessive, so as to retain only the one or more relevant solutions (with the lowest energy losses).

### Step d) of Determining a First Layout of Wind Turbines of the Farm

This step comprises determining a first layout of the wind turbines on each grid defined by each (first) pair of predefined first and second spacings and for each (second) pair of associated predefined first and second directions obtained in preceding step c), so as to limit the number of combinations. Each wind turbine is positioned at a point of intersection (a single wind turbine at one and the same point of intersection for obvious construction reasons) of the predetermined space by a first positioning algorithm. Preferably, this first positioning algorithm may be an optimization algorithm that makes it possible to obtain a first distribution that makes it possible to obtain a satisfactory annual energy produced. Advantageously, this first positioning algorithm may be a greedy algorithm that positions each wind turbine one after another so as to maximize the annual energy produced by each wind turbine that has just been added. The first wind turbine may be positioned arbitrarily in the predetermined space (at a discrete value of the first discrete mesh). The second wind turbine will be positioned at the point of intersection of the grid under consideration that makes it possible to maximize the annual energy produced by the two wind turbines, the chosen position of the n-th wind turbine at the point of intersection of the grid making it possible to maximize the annual energy produced by the n wind turbines. The use of a greedy algorithm makes it possible to easily obtain a first layout of the wind turbines in the predetermined space, thereby making it possible to initialize the optimization method of step e), in particular through the local optimization search method of following step e1).

According to one embodiment, for each grid under consideration (each grid defined by a first pair of predefined first and second spacings and by a second pair of predefined first and second directions associated with the first pair of predefined first and second spacings), the first positioning algorithm carries out at least the following steps:
arbitrarily defining the position of the first wind turbine at one of the points of intersection of the grid under consideration;
next, for each wind turbine to be positioned, successively:
   defining potential positions for the wind turbine to be positioned, the potential positions being formed by the points of intersection of the grid. In other words, points of intersection of the grid where the next wind turbine would advantageously be positioned are selected.
   computing the annual energy production of the positioned wind turbines and of the wind turbine to be positioned for the defined potential positions. Therefore, an annual energy production value is associated for each defined potential position. Moreover, the computation of the annual energy production takes into account the first discrete wind speed distribution, the second discrete wind direction distribution and the probability of occurrence. This computation also involves, in a known manner, the characteristics of the wind turbines, namely in particular the surface swept by the rotor of the wind turbine, the drag coefficient and/or the power coefficient.
   Choosing the position of the wind turbine to be positioned, corresponding to the maximum computed annual energy production value. The annual energy produced by wind turbines whose position is defined in the predetermined space is thus maximized. These defined positions will serve as a basis for determining the position of the next wind turbine, in particular for defining the potential positions of the next wind turbine to be positioned.
determining the first layout corresponding to the position of the predefined number of wind turbines among the points of intersection of the grid under consideration in the predetermined space.

Therefore, the first positioning algorithm is a greedy algorithm that comprises a step of arbitrarily positioning the first wind turbine, and that then iteratively positions an additional wind turbine at points of intersection of the grid under consideration until all of the wind turbines of the predefined number have been positioned on the grid. This greedy algorithm makes it possible, by virtue of the step of selecting potential positions, to speed up computation time while at the same time positioning the wind turbines expediently. Such an algorithm makes it possible to obtain a first layout suitable for the following step of locally optimizing the positioning search for each wind turbine.

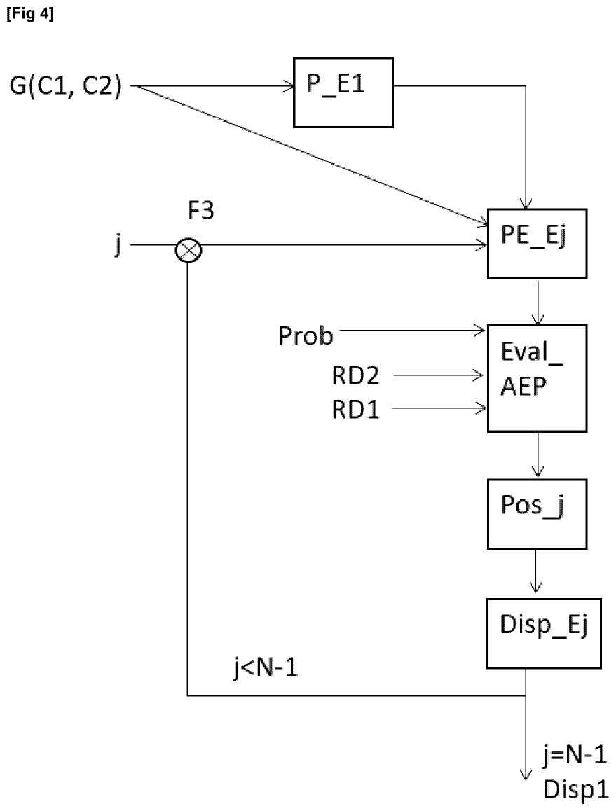

FIG. 4 illustrates, schematically and in a non-limiting manner, one example of a step for obtaining a first layout of the wind turbines on each selected grid according to the invention.

For this purpose, it is possible for example to use a greedy algorithm.

For each selected grid G(C1, C2) of the predetermined space, the position of the first wind turbine P_E1 is defined, for example arbitrarily.

Next, for each wind turbine j, a position is sought to maximize annual energy produced.

Thus, iteratively according to F3, potential positions PE_Ej for the wind turbine j to be positioned are defined one by one for each wind turbine, the potential positions PE_Ej being determined by the available points of intersection (that is to say those on which no wind turbine is planned for the time being) of the grid of the predetermined space.

Once these potential positions PE_Ej have been defined for the wind turbine j to be positioned, an evaluation Eval_AEP is carried out to determine, for each of these potential positions PE_Ej, the annual energy produced by the wind turbines that have already been positioned and the wind turbine j to be positioned in the predetermined space. For this evaluation Eval_AEP, the first and second discrete wind speed and direction distributions RD1 and RD2 and the probability of occurrence Prob of each wind speed in each wind direction are used in particular. It is possible, in a known manner, to use the characteristics of the wind turbines and the wake effects described above in this description.

It is then possible to choose the position Pos_j of the wind turbine j, the position corresponding to the maximum value of the annual energy produced in the previous step.

It is then possible to define a new layout Disp_Ej of the positioned wind turbines (including the wind turbine j) in the predetermined space. This new layout Disp_Ej will be used in the following iteration to determine the potential positions PE_Ej of the new wind turbine to be positioned and to evaluate the annual energy produced Eval_AEP.

The loop F3 is carried out for, j ranging from 1 to N−1, N being the predefined number of wind turbines in the predetermined space, taking into account the fact that the first wind turbine is positioned step-by-step P_E1.

Once all of the wind turbines have been positioned (that is to say when j=N−1), the last layout found Disp_Ej for each grid then corresponds to the first layout Disp1 of the wind turbines for each grid.

### Step e) of Improving the Position of the Wind Turbines on Each Grid

For each grid from step d), it is sought to improve annual energy by modifying the position of the wind turbines on the grid. This may be done in particular by steps e1 and e2, which are described below.

### Step e1) of Local Search Optimization

In this step, it is sought to improve annual energy production by modifying the position of the wind turbines of the farm, one by one, on each grid from step d).

To this end, a sequential order of modification of the positions of the wind turbines as determined by the first positioning algorithm is defined: in other words, the wind turbines are not necessarily repositioned in the same order as that in which they were determined by the first algorithm, and a different order is preferably used to improve the chances of obtaining a better solution.

Preferably, this sequential order is obtained randomly. Indeed, using a random function for the sequential order improves the quality of the optimization by avoiding optimization paths based on pre-established orders, these paths possibly biasing the optimization results.

Once the sequential order has been defined, each wind turbine is repositioned, one by one, by this defined sequential order, by finding an available point of intersection of the grid that maximizes annual energy production: if no other point of intersection of the grid makes it possible to improve annual energy production, the wind turbine under consideration is kept in its previously determined position. It is then possible to try to modify the position of the following wind turbine in the defined sequential order.

To determine the annual energy produced, the first and second discrete wind speed and wind direction distributions and the probability of occurrence are of course taken into account, these being directly dependent on the geographical position of the predetermined space and its local environment (presence of forests, mountains, geological features, buildings for example) and on the characteristics of the wind turbines.

The annual energy produced may in particular be determined using the formulas mentioned above, in particular using the formula [Math 1].

### Step e2) of Reproducing Step e1)

At the end of step e1), it is not possible a priori to know whether the layout of the wind turbines in each grid is optimum or whether an improvement may still be made. To further optimize the layout of the wind turbines on each grid, step e1) is reiterated as many times as necessary as long as, in this step, at least one wind turbine is repositioned at a point of intersection of the grid. Iteration is stopped when, in the last iteration of step e1), no wind turbine has been repositioned: it is then considered that the optimum layout of the predefined number of wind turbines on the grid under consideration has been found.

At the output of step e2), on each grid under consideration (corresponding to a first pair of predefined first and second spacings and to a second pair of predefined first and second directions associated with the first pair of predefined first and second spacings), a final layout of the wind turbines on each grid under consideration and an annual energy production associated with each of these final layouts (one for each grid under consideration) are obtained.

Preferably, in step e2), the sequential order is modified in each iteration of step e1) so as to limit the optimization paths based on pre-established orders.

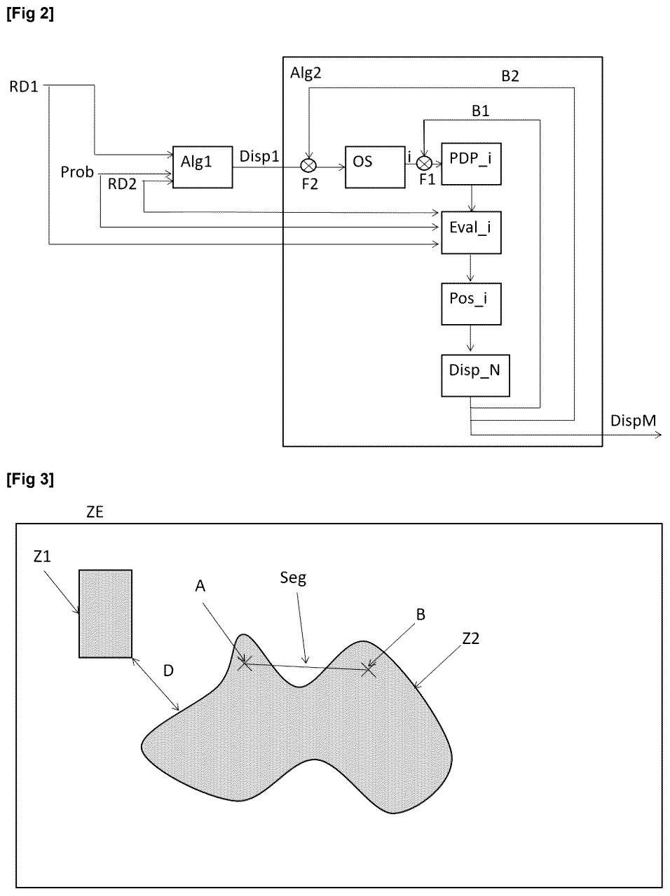

FIG. 2 illustrates, schematically and in a non-limiting manner, one example of an optimization search of the method according to the invention.

For each selected grid, a first layout Disp1 of the wind turbines on each of these grids is determined Alg1, taking into account, as input data, at least a first discrete wind speed distribution RD1, a second discrete wind direction distribution RD2 and the probability of occurrence Prob of each wind speed in each wind direction. The characteristics of the wind turbines and wake models may also be used to determine the annual energy produced in order to establish this first layout Disp1.

The data concerning wind, speed, direction and probability of occurrence of each speed value in each direction may be obtained in particular using a collector in a preliminary step. These data may serve in particular to establish a wind rose, known to those skilled in the art.

This first layout Disp1 may be improved, but is of sufficiently good quality to allow local optimizations of the subsequent steps. This step of determining Alg1 the first layout Disp1 of the wind turbines on each selected grid may be a greedy algorithm.

This first layout Disp1, which is obtained quickly by virtue of the greedy algorithm, is used as input datum for the following optimization step Alg2. This optimization step Alg2 modifies, one by one, the position of the various wind turbines of the first layout Disp1, at other points of intersection of the same grid, so as to increase the annual energy produced by the farm by testing other possible positions on the grid, while thus complying with the alignment constraints.

In more detail, this optimization step Alg2 comprises the following steps:
defining a sequential order OS of modification of the positions of the wind turbines, one by one. This sequential order OS may in particular be obtained using a random function.
Next, iteratively, for each selected grid, modifying the position of at least one wind turbine i, preferably of each wind turbine i, by carrying out the following sub-steps:
   determining possible positions PDP_i for the wind turbine i, these possible positions being the current position of the wind turbine i and the points of intersection of the grid at which no wind turbine is planned (the other wind turbines remaining in their position, either the initial position from the first layout or the already repositioned position).
   an evaluation Eval_i is then carried out to determine the annual energy produced for each possible layout (for each possible position PDP_i of the wind turbine i to be repositioned, the other wind turbines remaining in the last position set for them). The annual energy produced takes into account the first and second discrete wind speed and direction distributions RD1 and RD2, and also the probability of occurrence Prob of each wind speed in each wind direction. Thus, at the end of this evaluation step, an annual energy produced corresponds to each possible position PDP_i of the wind turbine i to be repositioned.
   retaining, as position POS_i of the wind turbine i, the possible position PDP_i that corresponds to the maximum value of the annual energy produced in the step Eval_i.
   thereby obtaining a new layout Disp_N of the wind turbines in the determined space. This new layout comprises the last positions of the wind turbines that have already been positioned and also the new position Pos_i of the wind turbine i.

The loop B1 then makes it possible to select F1 the following wind turbine in the defined sequential order (i becomes i+1) in order to carry out the same procedure for the following wind turbines.

Once all of the wind turbines have been repositioned by the loop B1, the steps of determining the sequential order OS and the loop B1 are reiterated multiple times for each selected grid for each of the wind turbines, one by one, the loop B1 comprising, for each wind turbine i to be repositioned, determining the possible positions PDP_i, evaluating the annual energy produced Eval_i for each possible position, choosing the position Pos_i of the wind turbine i to be repositioned and defining the new layout Disp_N.

Reiterating these steps multiple times makes it possible to improve the annual energy produced by the farm. Modifying the sequential order each time (through a random draw each time for example) makes it possible to further improve the annual energy produced.

The loop B2 ends when, during the last loop B1, no wind turbine has been repositioned (all of the wind turbines have been kept in the same position as the one obtained in the previous iteration).

Once the loop B2 has finished, the last layout Disp_N obtained becomes the final layout DispM for the selected grid.

To choose the definitive layout of the wind turbines, it is then possible to compare all of the final layouts of the various grids, and choose which layout makes it possible to maximize annual energy produced. It is this final layout that maximizes energy produced that is retained and that becomes the definitive layout. The wind turbines may then be constructed at the positions planned according to the definitive layout in the physical site of the predetermined space so as to obtain a wind farm.

### Step f) of Determining the Definitive Layout of the Wind Turbines in the Predetermined Space and of Constructing the Farm

Based on each final layout of the wind turbines obtained on each grid, the annual energy production of each of these final layouts is compared and the final layout having the highest annual energy production is chosen so as to maximize the output of the farm. The definitive layout of the wind turbines of the farm is then determined as corresponding to this optimum final layout.

Based on the obtained definitive layout, it is then possible to construct the wind turbines of the farm at the positions corresponding to the definitive layout in the predetermined space. By virtue of the use of grids, the wind turbines will be aligned in two directions and along lines that are distributed regularly in the space, so as to meet operational constraints and constraints specific to offshore operations.

In the above method, steps a) to f) (apart from the part of step f) concerning the construction of the wind farm) may be implemented by a computer, a server or a supercomputer. Steps a) to f) then constitute a method for positioning wind turbines in a predetermined space.

The invention may also relate to a computer program product implementing the method for positioning wind turbines in a predetermined space, having steps a) to f) (apart from the part of step f) concerning the construction of the wind farm) described above using computer means, such as a computer, a cell phone or a tablet. The computer program product may be downloadable from a communication network and/or recorded on a medium able to be read by a computer and/or able to be executed by a processor or a server, and comprises program code instructions for implementing the positioning method according to one of the above features when the program is executed on a computer or on a cell phone. Indeed, the positioning method described above is particularly suitable for implementation on a computer. It may thus be implemented easily, and results may be obtained quickly.

The invention also relates to a wind farm obtained using the method for constructing a wind farm as described above. This farm enables a good energy output by taking into account statistical data concerning wind on the site under consideration and taking into account alignment constraints for the construction of the farm.

FIG. 7 illustrates, schematically and in a non-limiting manner, one example of creating a grid in a predetermined space.

The predetermined space Esp comprises two non-connected and non-convex areas Z1 and Z2.

In order to obtain a grid defined by the first pair of first and second spacings R1 and R2 and by the second pair of first and second directions O1 and O2, the space is divided by first lines L1 and by second lines L2. The first lines L1 are parallel to one another and spaced regularly by the second spacing R2 along the second lines L2, and the second lines L2 are parallel to one another and spaced regularly by the first spacing R1 along the first lines L1. Moreover, the first lines L1 are oriented in a first direction forming an angle θ1 with the direction E of the reference frame (O1, N, E), which is an arbitrarily defined reference frame, for example, O1 is a chosen geographical point, N is the North direction and E is the East direction. The second lines L2 are oriented in a second direction forming an angle θ2 with the direction E of the same reference frame (O1, N, E). The angles θ1 and O2 are chosen such that the first lines L1 intersect the second lines L2.

One of the first lines L1 and one of the second lines L2 may be positioned arbitrarily in the space and then serve as a reference for the positions of the other first lines L1 and second lines L2.

The points of intersection, represented by the crosses, located in the predetermined space Esp (or on the boundary of this space) constitute the grid. Unit cells, as represented by the unit cell M1, which is hatched, may be formed between the points of intersection. It may be noted that the only point of intersection located in the area Z2 is part of the grid, even though it is not linked to a unit cell since it is not connected to any other point of intersection to which it could be connected by a unit cell.

The points of intersection of the grid are points where it is potentially possible to position wind turbines in the predetermined space Esp.

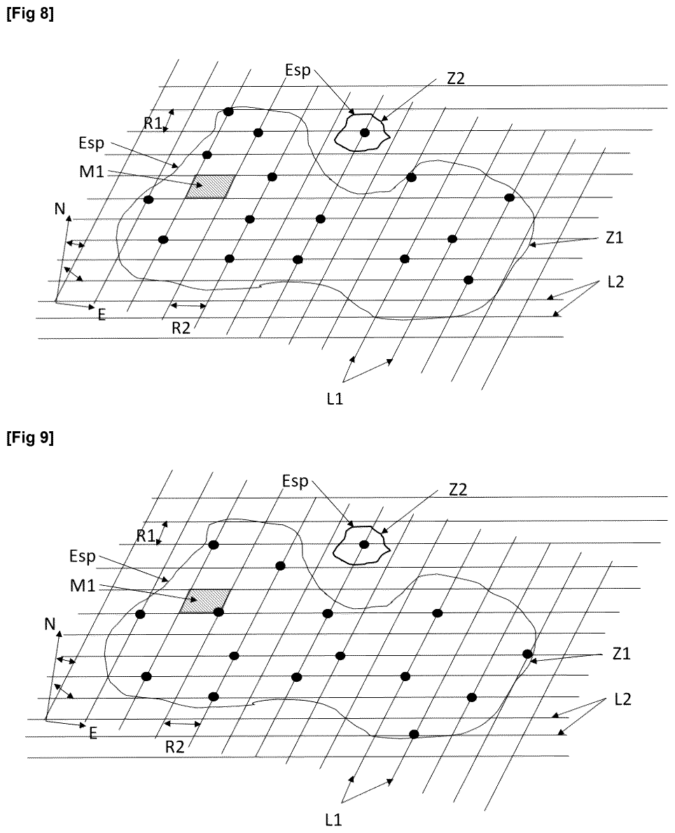

FIG. 8 illustrates, schematically and in a non-limiting manner, a first layout obtained using the method according to the invention for positioning sixteen wind turbines in the predetermined space Esp, the same space as the one in FIG. 7, and on the grid obtained in FIG. 7.

In this figure, references identical to those in FIG. 7 correspond to the same elements and will not be detailed again. The crosses representing the points of intersection in FIG. 7 have not been shown in FIG. 8 for ease of reading. The black dots represent the positions of the sixteen wind turbines of the first layout in the predetermined space, each wind turbine being positioned at a point of intersection of the grid from FIG. 7.

This first layout corresponds to the one obtained for the grid in FIG. 7 following step d) of the method according to the invention.

FIG. 9 illustrates, schematically and in a non-limiting manner, a final layout obtained using the method according to the invention for repositioning the sixteen wind turbines following the first layout obtained in FIG. 8 in the predetermined space Esp, the same space as the one in FIG. 7, and on the grid obtained in FIG. 7.

In this figure, references identical to those in FIG. 7 or 8 correspond to the same elements and will not be detailed again. The crosses representing the points of intersection in FIG. 7 have not been shown in FIG. 9 for ease of reading. The black dots represent the positions of the sixteen wind turbines of the final layout at the end of steps e1) and e2) in the predetermined space, each wind turbine being positioned at a point of intersection of the grid from FIG. 7.

### EXAMPLES

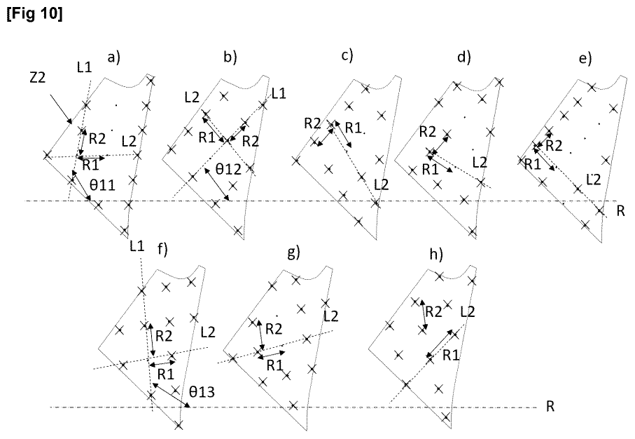

FIG. 10 illustrates one example of searching for positions of wind turbines in a predetermined space Z2, which is a non-convex space.

In this example, it is sought to position twelve wind turbines in the predetermined space Z2, taking into account the alignment constraints of the wind turbines in two non-collinear directions.

The turbines under consideration are turbines with a nominal power of 10 MW, the height of the nacelle of which is positioned 119.8 m above ground level and the diameter of the rotor of which is 198 m. The distance between the turbines in the predetermined space Z2 is greater than 4 times the diameter of the rotor of the turbines.

The wind data used for this example correspond to those from: Baker, N. F., Thomas, J. J., Stanley, A. P. J., and Ning, A. IEA Task 37 Wind Farm Layout Optimization Case Studies, https://doi.org/10.5281/zenodo.5809681, 2021

Diagrams a) to h) represent various positions of the wind turbines in this predetermined space Z2, based on various grids in this predetermined space Z2. For this example, various grids were tested with the following characteristics:
The angle of the direction of the first lines L1 with respect to the reference R varies from 1° to 359° in steps of 1°,
The angle of the direction of the second lines L2 with respect to the reference R varies from 0° to the angle of the direction of the first lines L1−1° in steps of 1°,
The first spacing R1 of the first lines L1 along the second lines L2 varies from 4 times the diameter of the rotors to 8 times the diameter of the rotors in steps of 0.25 times the diameter of the rotors; and
The second spacing R2 of the second lines L2 along the first lines L1 varies from 4 times the diameter of the rotors to 8 times the diameter of the rotors in steps of 0.25 times the diameter of the rotors.
   Diagrams a) to h) represent only a few grids out of those tested.

For the various diagrams in FIG. 10:
The “round” dots represent possible positions where it is possible to place the wind turbines on the grid. They are therefore at the intersections of the first lines L1 and second lines L2 of the grid in the predetermined space Z2;
The crosses represent the positions of the wind turbines that make it possible to maximize energy recovery on the grid under consideration;
The dashed lines represent the direction of the first lines L1 or second lines L2;
The dot-and-dash lines represent a reference R used for the position of the first lines. For example, R may be a line representing the West-East direction.
The spacings R1 represent the spacing of the first lines L1 along the second lines L2;
The spacings R2 represent the spacing of the second lines L2 along the first lines L1.
The first directions O11, O12 and O13 represent the directions of the first lines L1 with respect to the reference R.

Thus, on each of the diagrams shown in FIG. 10, a different grid is used in the same predetermined space Z2.

For diagrams b), c), d) and e), the first lines L1 are parallel to the lines L1 shown in diagram b).

For diagrams f), g) and h), the first lines L1 are parallel to the lines L1 shown in diagram f).

Depending on the various grids used, the optimum positions of the wind turbines on each grid are different.

The average annual energy recovered for each positioning diagram a) to h) varies between 486611 MWh and 487467.6 MWh, that is to say a gain of 856.6 MWh for the optimum configuration according to the invention.

1-9. (canceled)

10. A method for constructing a wind farm in a predetermined space, the wind farm having a predefined number of wind turbines comprising a first discrete wind speed distribution, a second discrete wind direction distribution and a probability of occurrence of each discrete wind speed value in each discrete wind direction value of the first and second discrete distributions, comprising steps of:
a) for pairs of predefined first and second spacings, and for pairs of predefined first and second directions, forming grids in the predetermined space, each grid including points of intersection between first lines oriented in a predefined first direction and second lines oriented in a predefined second direction, the first lines being spaced by the predefined second spacing along the predefined second direction and the second lines being spaced by the predefined first spacing along the predefined first direction, the grid comprising at least one cell delimited by points of intersection;
b) for each grid in the predetermined space, determining an average annual energy production of a mini-farm including wind turbines positioned at all points of intersection of a unit cell or multiple connected unit cells of the grid, based on the first discrete wind speed distribution, on the second discrete wind direction distribution and on a probability of occurrence;
c) for each pair of predefined first and second spacings, associating at least one pair of predefined first and second directions that maximizes the annual energy production of the mini-farm;
d) for each grid corresponding to a pair of predefined first and second spacings and to a pair of predefined first and second directions associated in step c), determining a first layout of the predefined number of wind turbines, each wind turbine being positioned at one of the points of intersection of the grid by a first positioning algorithm;
e) then, for each grid used in step d), modifying a position of the wind turbines in order to improve annual energy production, and obtaining a layout of the predefined number of wind turbines on each grid under consideration and an annual energy production for each layout; and
f) determining a layout of the wind turbines in the predetermined space, the layout corresponding to a last layout obtained in step e) of the grid that maximizes annual energy production, and constructing the wind farm by erecting the wind turbines at positions of the layout in the predetermined space to generate energy from wind.

11. The method for constructing a wind farm as claimed in claim 10, wherein, in step e) of modifying position of the wind turbines for each grid used in step d), comprising steps of:
e1) for each grid used in step d), defining a sequential order of modification of positions of the wind turbines determined by a first positioning algorithm and repositioning each wind turbine in a defined sequential order one by one by finding a point of intersection of the grid maximizing annual energy production based on the first discrete wind speed distribution, on the second discrete wind direction distribution and on the probability of occurrence;
e2) reiterating step e1) until, at an end of a step e1), no wind turbine has been repositioned, and obtaining a last layout of a predefined number of wind turbines on each grid under consideration and an annual energy production for each final layout.

12. The method for constructing a wind farm as claimed in claim 11, wherein the sequential order is obtained randomly.

13. The method for constructing a wind farm as claimed in claim 11, wherein the sequential order is modified in each iteration of step e1).

14. The method for constructing a wind farm as claimed in claim 12, wherein the sequential order is modified in each iteration of step e1).

15. The method for constructing a wind farm as claimed in claim 10, wherein, before step a), statistical wind data are measured using by measurements, to determine the first and second discrete distributions and the probabilities of occurrence of each wind speed in each wind direction of the first and second discrete distributions.

16. The method for constructing a wind farm as claimed in claim 11, wherein, before step a), statistical wind data are measured, to determine the first and second discrete distributions and the probabilities of occurrence of each wind speed in each wind direction of the first and second discrete distributions.

17. The method for constructing a wind farm as claimed in claim 12, wherein, before step a), statistical wind data are measured, to determine the first and second discrete distributions and the probabilities of occurrence of each wind speed in each wind direction of the first and second discrete distributions.

18. The method for constructing a wind farm as claimed in claim 13, wherein, before step a), statistical wind data are measured, to determine the first and second discrete distributions and the probabilities of occurrence of each wind speed in each wind direction of the first and second discrete distributions.

19. The method for constructing a wind farm as claimed in claim 14, wherein, before step a), statistical wind data are measured, to determine the first and second discrete distributions and the probabilities of occurrence of each wind speed in each wind direction of the first and second discrete distributions.

20. The method for constructing a wind farm as claimed in claim 10, wherein the predetermined space comprises at least one of non-connected areas and non-convex areas.

21. The method for constructing a wind farm as claimed in claim 11, wherein the predetermined space comprises at least one of non-connected areas and non-convex areas.

22. The method for constructing a wind farm as claimed in claim 12, wherein the predetermined space comprises at least one of non-connected areas and non-convex areas.

23. The method for constructing a wind farm as claimed in claim 10, wherein, for each grid under consideration, the first positioning comprises steps of:
arbitrarily defining a position of the first wind turbine at one of the points of intersection of the grid;
then, for each wind turbine to be positioned, successively:
defining potential positions for the wind turbine to be positioned, the potential positions being formed by the points of intersection of the grid that are located between a minimum distance and a maximum distance from all positioned wind turbines;
computing the annual energy production of the positioned wind turbines and of the wind turbine to be positioned for the defined potential positions based on the first discrete wind speed distribution, on the second discrete wind direction distribution and on the probability of occurrence;
choosing a position of the wind turbine to be positioned, corresponding to a maximum computed annual energy production value;
determining the first layout corresponding to a position of a predefined number of wind turbines among the points of intersection of the grid under consideration in the predetermined space.

24. The method of constructing a wind farm as claimed in claim 10, wherein, in step c): calculating a difference between annual energy production of a mini-farm obtained in step b) and annual energy production of a single wind turbine multiplied by a number of wind turbines in the mini-farm.

25. A wind farm obtained using the method for constructing a wind farm as claimed in claim 10.

26. A wind farm obtained using the method for constructing a wind farm as claimed in claim 11.

27. A wind farm obtained using the method for constructing a wind farm as claimed in claim 12.

28. A wind farm obtained using the method for constructing a wind farm as claimed in claim 13.

29. A wind farm obtained using the method for constructing a wind farm as claimed in claim 14.
